(19) United States
(12) Patent Application Publication
(10) Pub. No.: US 2003/0188305 A1
(43) Pub. Date: Oct. 2, 2003

(54) Installer, external storage medium, computer system and method and program products for installing application program

(76) Inventor: Kiyoaki Morimoto, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/372,204

(22) Filed: Feb. 25, 2003

(30) Foreign Application Priority Data
Feb. 27, 2002 (JP) JP2002-051366

(51) Int. Cl. G06F 9/445; G06F 9/44

(52) U.S. Cl. 717/174; 717/168

(57) ABSTRACT

A computer system is capable of easily and accurately executing an installation of an application program. A personal computer is provided with a CPU, a ROM, a RAM, an inputting device such as a keyboard and/or a mouse, a displaying device such as a display, an external storage media drive, which is connected with an external storage medium such as a CD-ROM (including a CD-R and a CD-R/W) and/or a DVD-ROM, for carrying out reading and writing of information between the external storage medium, a hard disk and a bus. An installer, which has a function of simultaneously displaying a manual of an application program stored in the external storage medium and an installation situation of the application program in the displaying device, is read in the RAM or the hard disk and executed when the application stored in the external storage medium is read out by the external storage media drive and installed in the hard disk.

### FIELD OF THE INVENTION

This invention relates to an installer for installing an application program in a computer system, an external storage medium, a computer system, and method and program products for installing an application program. In particular, this invention relates to an installer, an external storage medium, a computer system, and method and program products for installing an application program, which is capable of displaying a manual of an application program and an installation situation at the same time.

### BACKGROUND OF THE INVENTION

In the case of a general and conventional installation of an application program, an installer for installing an application program is read out from a compact disc read-only memory (CD-ROM) and the application program is installed by the use of the installer when the CD-ROM storing the application program is inserted into a CD-ROM drive of a personal computer.

In the case of the general and conventional installation of an application program, however, there is a disadvantage in that a user must refer to a manual book attached to an application program in the event that the installation of the application program should fail halfway in some causes, so that there was a case where the user could not take appropriate measures immediately, because only it was possible to call a user's attention by displaying contents of a wizard, and so on, on the display screen under installation.

### SUMMARY OF THE INVENTION

Accordingly, it is an object of the invention to provide an installer, an external storage medium, a computer system, and method and program products for installing an application program, in which an installation of an application program can be easily and accurately executed.

According to the first feature of the invention, an installer, which is an installer for installing an application program in a computer system, displays a manual of an application program and also displays an installation situation of the application program.

According to the second feature of the invention, an external storage medium, which is an external storage medium for storing an application program of a computer system, stores (in such a manner to be read by a computer) a manual storing region for storing a manual of an application program, an application storing region for storing the application program and a function of displaying the manual of the application program stored in the manual storing region and also displaying an installation situation of the application program when an installation of the application program stored in the application storing region is executed.

According to the third feature of the invention, a computer system, which comprises displaying means for displaying images, inputting means for inputting signals in accordance with characters and/or orders, storing means for storing an application program and/or data and external storage media controlling means, which is connected with an external storage medium, for carrying out reading and writing of information between the external storage medium, further comprises an installer for displaying a manual of an application program stored in the external storage medium and also displaying an installation situation of the application program when the application program stored in the external storage medium is read out by the external storage media controlling means and is installed in the storing means.

According to the forth feature of the invention, a method for installing an application program, which is a method for installing an application program in a computer system, comprises the step of displaying a manual of an application program and an installation situation of the application program at the same time when an installation of the application program is executed.

According to the fifth feature of the invention, program products for installing an application program comprises the functions of executing an installation of an application program in a computer system and displaying a manual of the application program and an installation situation of the application program at the same time when the installation of the application program is executed.

### BRIEF DESCRIPTION OF THE DRAWINGS

The invention will be described in more detail in conjunction with the appended drawings, wherein:

FIG. 1 is a schematic diagram showing an example of a composition of a computer system according to the present invention;

FIG. 2 is a diagram showing an installation of an application program to personal computer 10 from external storage medium 20;

FIG. 3 is a flowchart showing the process for installing an application program according to the present invention; and

FIG. 4 is an example of a screen image displayed in displaying device 15.

### DETAILED DESCRIPTION OF THE PREFERRED EMBODIMENTS

Referring to accompanying drawings, embodiments of an installer, an external storage medium, a computer system, and method and program products for installing an application program according to the present invention will be explained as follows.

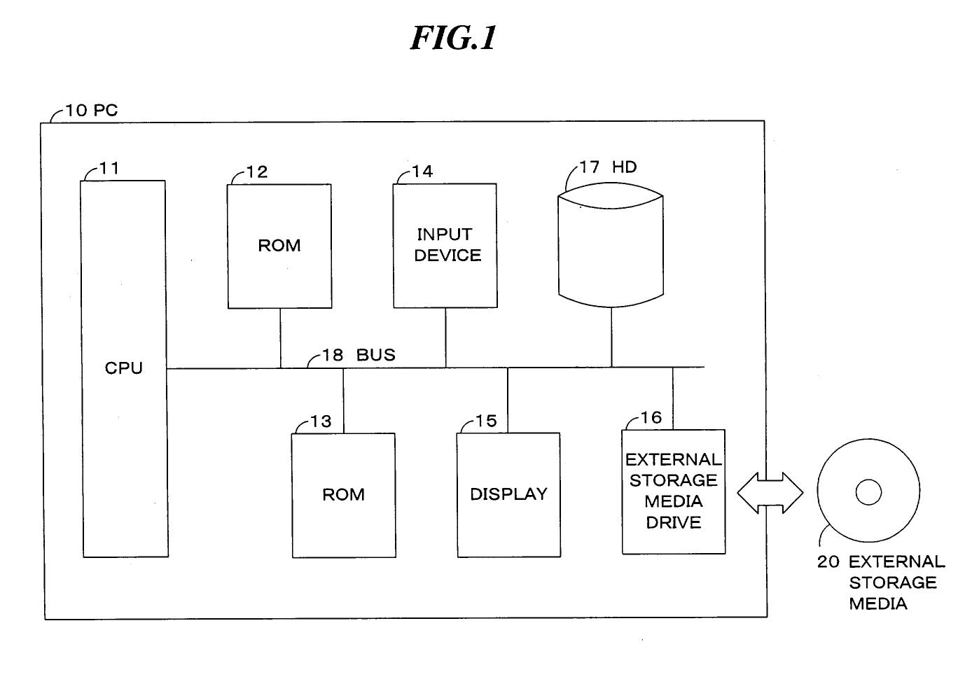

FIG. 1 is a schematic diagram showing an example of a composition of a computer system according to the present invention. Personal computer (PC) 10 comprises central processing unit (CPU) 11 for executing an operating system (OS) and/or an application program and so on, and controlling each component, read-only memory (ROM) 12 for storing a basic input/output system (BIOS) and so on, random access memory (RAM) 13 for storing an executed operating system and/or application program and so on, inputting device 14 such as a keyboard and/or a mouse for inputting signals in accordance with characters and/or orders, displaying device 15 such as a display for displaying images, external storage media drive 16, which is connected with external storage medium 20 such as a compact disc read-only memory (CD-ROM) (including a CD-R and a CD-R/W) and/or a DVD read-only memory (DVD-ROM), for carrying out reading and writing of information between the external storage medium 20, hard disk (HD) 17 for storing an operating system, applications, data, and so on, and bus 18 for connecting among each component.

And then, in personal computer 10, when an application program stored in external storage medium 20 is read out by external storage media drive 16 and is installed in hard disk 17, an installer for displaying a manual of the application program stored in external storage medium 20 and an installation situation of the application program on displaying device 15 at the same time is read in random access memory 13 or hard disk 17 and is executed.

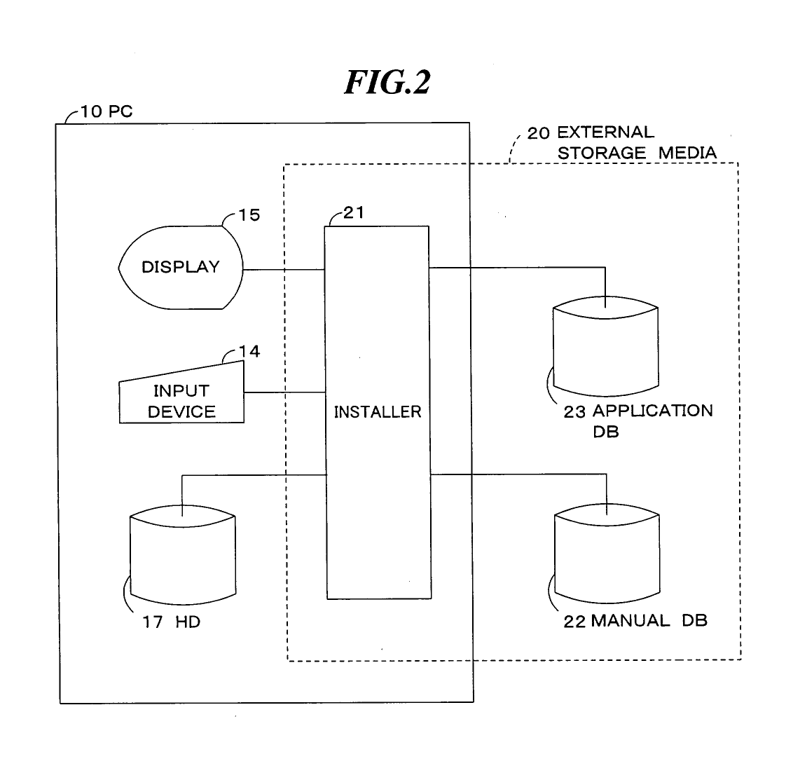

FIG. 2 is a diagram showing an installation of an application program to personal computer 10 from external storage medium 20.

As shown in FIG. 2, external storage medium 20 comprises installer 21 for installing an application program, manual database (manual storing region) 22 for storing a manual of the application program and application database (application storing region) 23 for storing the application program.

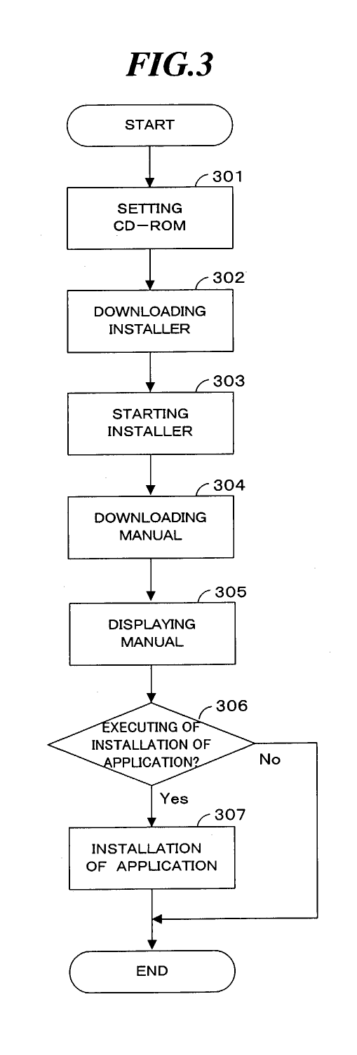

FIG. 3 is a flowchart showing the process for installing an application program. In FIG. 1 to FIG. 3, when external storage medium 20 such as a compact disc read-only memory (CD-ROM) (including a CD-R and a CD-R/W) and/or a DVD read-only memory (DVD-ROM) is set in personal computer 10 (in the step 301), installer 21 is downloaded in random access memory 13 or hard disk 17 in personal computer 10 from external storage medium 20 (in the step 302).

Next, installer 21 is started (in the step 303) and a manual of the application program stored in manual database 22 is downloaded in random access memory 13 or hard disk 17 in personal computer 10 (in the step 304). The downloaded manual is displayed in displaying device 15 (in the step 305).

And then, when execution of an installation of the application program is selected by the operation of inputting device 14 (in the step 306), the installation of the application program is started (in the step 307). At this time, the manual of the application program and an installation situation of the application program are displayed in displaying device 15 at the same time.

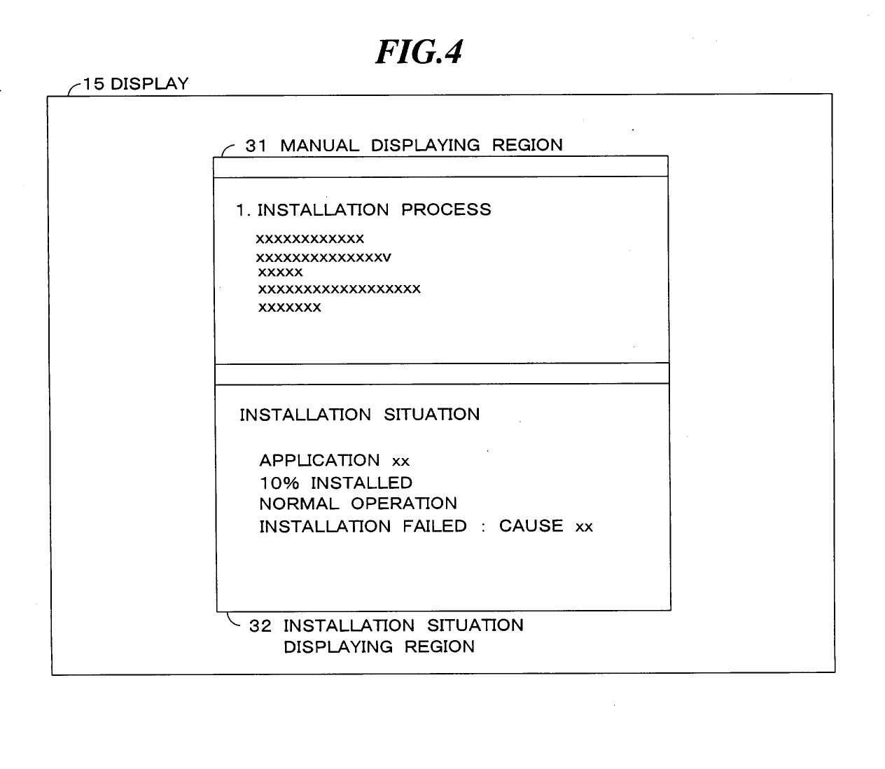

FIG. 4 is an example of a screen image displayed in displaying device 15. As shown in FIG. 4, an installation situation is also displayed in installation situation displaying region 32 at the same time that the manual of the application program is displayed in manual displaying region 31 when the installation of the application program is executed, so that the manual displayed in manual displaying region 31 can be immediately referred, even if the installation fails halfway. Therefore, an installation of an application program can be easily and accurately executed on the grounds that appropriate measures can be immediately taken in accordance with the situation.

And, above-mentioned installer 21 is stored in external storage medium 20 such as a compact disc read-only memory (CD-ROM) (including a CD-R and a CD-R/W) and/or a DVD read-only memory (DVD-ROM) with application program as an install program.

The installer, the external storage medium, the computer system, and the method and the program products for installing an application program according to the present invention are described as mentioned above, and the installer, the application program and the manual of the application program can be also downloaded from a server through the internet.

As mentioned above, according to the installer, the external storage medium, the computer system, and the method and the program products for installing an application program according to the present invention, a manual of an application program and an installation situation of the application program are simultaneously displayed at the time of an installation of the application program, so that the installation of the application program can be easily and accurately executed.

Although the invention has been described in its preferred form with a certain degree of particularity, it is understood that the present disclosure of the preferred form has been changed in the details of construction and the combination and arrangement of parts may be resorted to without departing from the spirit and the scope of the invention as hereinafter claimed.

What is claimed is:

1. An installer, which is an installer for installing an application program in a computer system, displays a manual of an application program and also displays an installation situation of the application program.

2. An external storage medium, which is an external storage medium for storing an application program of a computer system, storing (in such a manner to be read by a computer):
a manual storing region for storing a manual of said application program;
an application storing region for storing said application program; and
a function of displaying said manual of said application program stored in said manual storing region and also displaying an installation situation of said application program when an installation of said application program stored in said application storing region is executed.

3. The external storage medium of claim 2 is a compact disc read-only memory.

4. The external storage medium of claim 2 is a DVD read-only memory.

5. A computer system, which comprises displaying means for displaying images, inputting means for inputting signals in accordance with characters and orders, storing means for storing an application program and data and external storage media controlling means, which is connected with an external storage medium, for carrying out reading and writing of information between the external storage medium, further comprising:
an installer for displaying a manual of an application program stored in said external storage medium and also displaying an installation situation of said application program when said application program stored in said external storage medium is read out by said external storage media controlling means and is installed in said storing means.

6. The computer system of claim 5, wherein said external storage media controlling means is a compact disc read-only memory drive.

7. The computer system of claim 5, wherein said external storage media controlling means is a DVD read-only memory drive.

8. A method for installing an application program, which is a method for installing an application program in a computer system, comprising the step of:
displaying a manual of an application program and an installation situation of the application program at the same time when an installation of the application program is executed.

9. The method for installing an application program of claim 8, wherein
the installation of the application program is executed by an external storage medium connected with a computer system.

10. The method for installing an application program of claim 9, wherein the external storage medium is a compact disc read-only memory.

11. The method for installing an application program of claim 9, wherein the external storage medium is a DVD read-only memory.

12. The method for installing an application program of claim 8, wherein the installation of the application program is executed by a server connected with a network.

13. The method for installing an application program of claim 12, wherein the network is Internet.

14. Program products for installing an application program comprising the functions of:
executing an installation of an application program in a computer system; and
displaying a manual of the application program and an installation situation of the application program at the same time when the installation of the application program is executed.

15. The program products for installing an application program of claim 14, wherein
said function of executing an installation of an application program is executed by an external storage medium connected with a computer system.

16. The program products for installing an application program of claim 15, wherein said external storage medium is a compact disc read-only memory.

17. The program products for installing an application program of claim 15, wherein said external storage medium is a DVD read-only memory.

18. The program products for installing an application program of claim 14, wherein said function of executing an installation of an application program is executed by a server connected with a network.

19. The program products for installing an application program of claim 18, wherein said network is Internet.
